(19) United States
(12) Patent Application Publication
(10) Pub. No.: US 2003/0163562 A1
(43) Pub. Date: Aug. 28, 2003

(54) Remote information logging and selective reflections of loggable information

(76) Inventors: Daniel E. Ford, Granite Bay, CA (US); Steven V. Britt, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/082,245

(22) Filed: Feb. 26, 2002

(51) Int. Cl. G06F 15/173

(52) U.S. Cl. 709/224

(57) ABSTRACT

Methods (as well as apparatus and software that implement the methods) of remote information logging and selective reflections of loggable information are disclosed. One such method comprises: receiving a notice of locally-originated loggable information; determining whether said information satisfies a first criterion; and notifying, if said first criterion is satisfied, a remote logger service of said information. Another such method comprises: receiving multiple instances of remotely-originated loggable information; and making entries in a local log for said multiple instances of remotely-originated loggable information. And yet another such method comprises: providing access to a local log of remotely-originated information; determining whether information corresponding to an entry in said local log satisfies a first criterion; and notifying, if said first criterion is satisfied, a remote service of said information.

### FIELD OF THE INVENTION

The invention is generally directed to the field of information logging, and more particularly to selective reflection of locally-originated loggable information to a remote log as well as local logging of remotely-originated loggable information and selective reflection thereof to a remote support/maintenance provider.

### BACKGROUND OF THE INVENTION

In the Background Art, information logging is a local process. Within a computing device, a process or service is executed whose job it is to record information about a particular unit within the computing device. Such a computing device can be, e.g., a server that is part of, or can use the capabilities of, a storage area network.

In a storage area network (“SAN”) or other storage environment according to the Background Art, it is known to run a storage area manager (“SAM”) process on a server within the network. As its name implies, the SAM process, in part, manages the interaction between components of the storage environment as well as interaction of application programs having storage needs (clients) with components of the storage environment. As part of this management function, the SAM process can remotely load information logs from components of the storage environment and/or clients of the storage environment, i.e., logs that are local with respect to the component or client. By remotely reviewing the various local logs, the SAM process can sometimes detect probable causes of a problem.

Often, the clocks used by the components and/or clients are out of sync. As such, an entry in the local log of a client might indicate that an entry in the log took place at 9:00 am while an entry in the local log of a component would indicate a related entry occurred at 9:01 am. It would appear that the entry in the component's log occurred later in time than the entry in the local log of the client. But this presumes that the clocks of the component and client are in sync. It is equally possible that the clocks are out of sync, i.e., that the logged events actually occurred at the same time or that the event in the log of the component occurred before the event in the log of the client.

In the monitoring art as it applies to disk arrays (arrays of disk drives), it is known to provide a disk array with its own modem and dedicated telephone line. If the processor within the disk array determines that operational statistics fall outside of a set of tolerances, the processor alerts the customer support center, and then provides relevant data, via the modem.

Alternatively, several disk arrays can share a service processor that is provided with its own modem and dedicated telephone line. The service processor monitors the operational statistics of the disk arrays for which it is responsible. Should one of the disk arrays exhibit operational statistics that fall outside of the pre-determined tolerances, then the service processor alerts the customer support center via the modem and relays the relevant data.

FIG. 5 is a block diagram depiction of the Background Art. In FIG. 5, a redundant array of independent disks (“RAID”) 502 is depicted as including a microprocessor 504 and a modem 506. The modem 506 connects to a customer support center 516 via a dedicated phone line. Also in FIG. 5, an intranet 508 is depicted as including plural disk arrays 510, a service processor 512 and modem 514. The modem 514 connects to the customer support center via a dedicated phone line.

A disadvantage of the system of FIG. 5 is that a modem and a dedicated telephone line are required for each processor that performs a monitoring function.

### SUMMARY OF THE INVENTION

The invention, in part, provides a method (as well as an apparatus and software that implement the method) of logging information, the method comprising: receiving a notice of locally-originated loggable information; determining whether said information satisfies a first criterion; and notifying, if said first criterion is satisfied, a remote logger service of said information.

The invention, also in part, provides a method (as well as an apparatus and software for implementing the method) of logging information, the method comprising: receiving multiple instances of remotely-originated loggable information; and making entries in a local log for said multiple instances of remotely-originated loggable information.

The invention, also in part, provides a method (as well as an apparatus and software that implement the method) of logging information, the method comprising: providing access to a local log of remotely-originated information; determining whether information corresponding to an entry in said local log satisfies a first criterion; and notifying, if said first criterion is satisfied, a remote service of said information.

Additional features and advantages of the invention will be more fully apparent from the following detailed description of the preferred embodiments, the appended claims and the accompanying drawings.

### BRIEF DESCRIPTION OF THE DRAWINGS

The invention will be explained in more detail below, by way of example with reference to exemplary embodiments as illustrated in the drawings, wherein:

FIG. 1 is a block diagram depiction of a data logging and reflection system according to a first embodiment of the invention.

FIG. 2 is a block diagram depiction of a data logging and reflection system according to a second embodiment of the invention.

FIG. 3 is a flowchart of steps carried out by the first embodiment of the invention.

FIG. 4 is a flowchart of steps performed by the second embodiment of the invention.

FIG. 5 is a block diagram depiction of the Background Art.

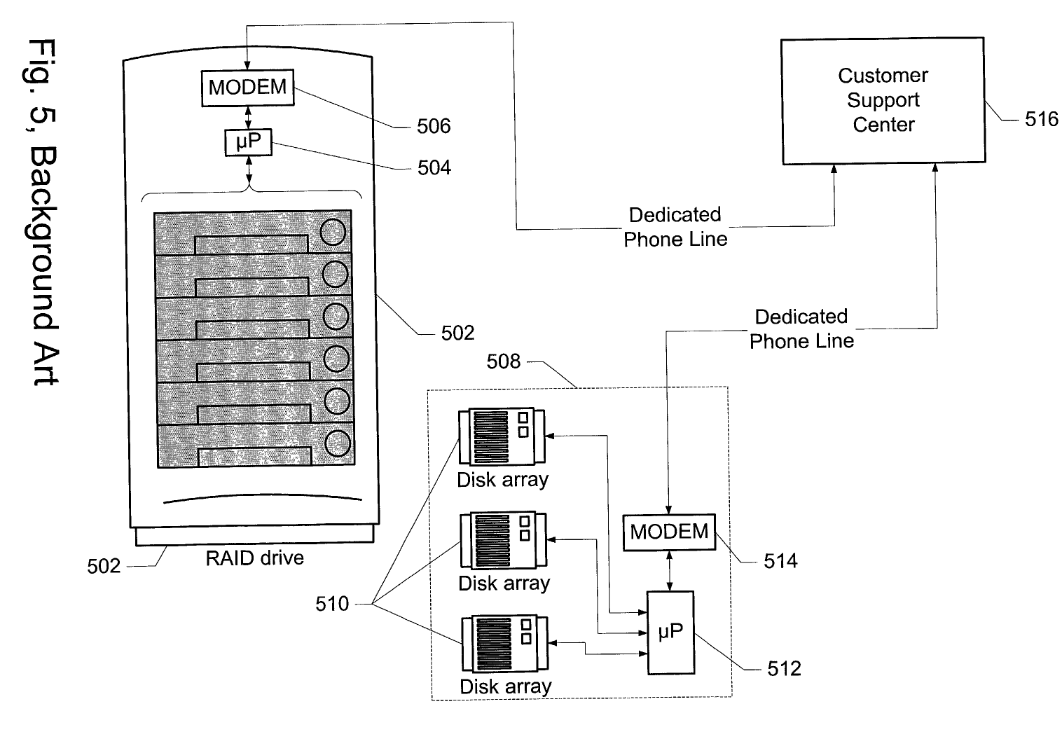

### DETAILED DESCRIPTION OF THE PREFERRED EMBODIMENTS

It should be noted that two terms are commonly used to refer to the recording of operational data: logging; and tracing. Some may characterize the term logging as referring to low-volume, high importance information that might get recorded in a normally operating device under observation. And some may characterize the term tracing as referring to recording of debugging and diagnostic information of which the volume generated is usually higher but the importance is lower. Typically, the primary difference between the terms logging and tracing is the importance of the information being recorded in the frequency or volume of that information. The present invention can apply to both logging and tracing. For simplicity, the present application has been couched in terms of logging but it should be understood that the present invention is equally applicable to tracing.

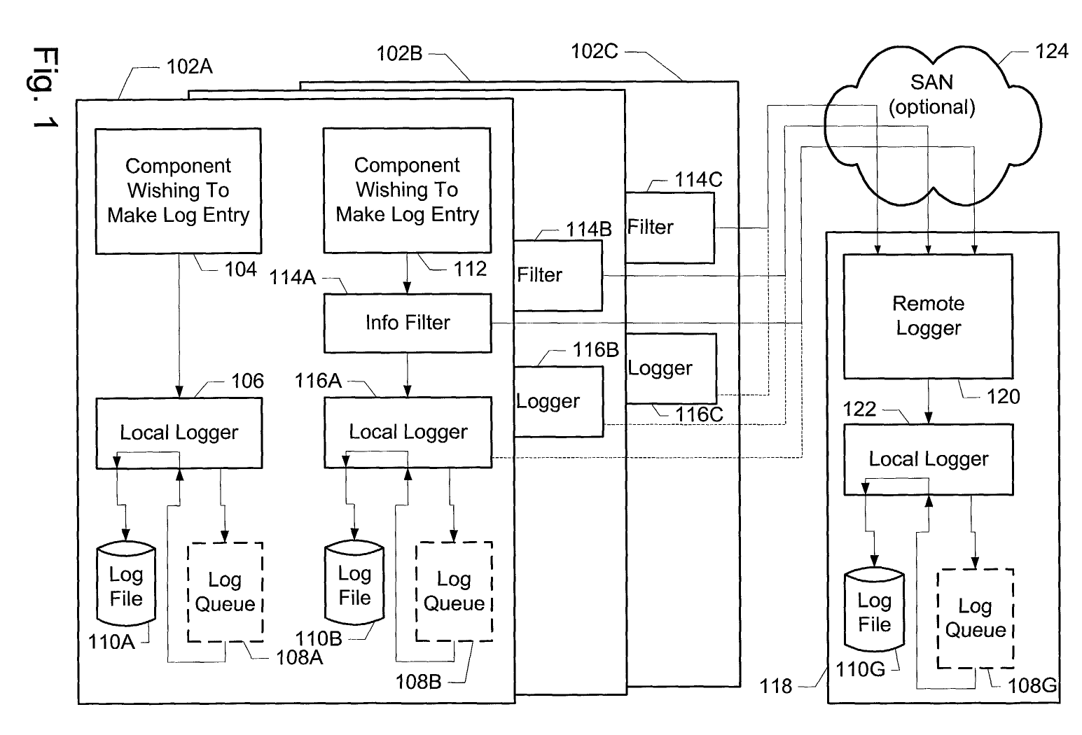

FIG. 1 is a block diagram depiction of a data logging and reflection system according to a first embodiment of the invention.

In FIG. 1, a server 118 functions, at least in part, as a storage area manager (“SAM”) server. Computing devices, e.g., servers 102A, 102B and 102C, represent devices that are monitored by, make use of and/or interact with the SAM server 118. Each of the clients 102A, 102B and 102C can have the components 104, 106 and 112 as well as 110A, 110B, 110C (obscured in drawing), 110D (obscured in drawing), 110E (obscured in drawing) and 110F (obscured in drawing), 108A, 108B, 108C (obscured in drawing), 108D (obscured in drawing), 108E (obscured in drawing), and 108F (obscured in drawing), 114A, 114B and 114C, and 116A, 116B and 116C, respectively, that are at least similar but not necessarily the same. Only the details of the client 102A will be discussed.

In the client 102A, there are at least two ways to log information. The first manner in which information can be logged is a blind technique in which no information is filtered out. A component or program/service 104 wishing to make a log entry calls a logger program/service 106 directly using a blind logging call. The local logger 106 stores every piece of loggable information from the component 104 in log file 110A. An optional aspect is for the local logger 106 to call a log queue program/service 108A should the volume of loggable information from the component 104 exceed the rate in which the local logger 106 can write to the log file 110A.

The second manner for logging information is a selective technique, i.e., not all of the information is logged, but rather some is filtered out and discarded. A component or program/service 112 wishing to selectively log information calls an information filter program/service 114. The filter 114A calls a local logger program/service 116A to handle information that the filter 114A wishes to log and/or reflect. If the information is to be logged, then the local logger 116A interacts with a log file 110B and optionally a log queue 108B in the same manner as does the local logger 106.

In the circumstance that the filter 114A has been called in a manner that instructs it to reflect certain instances of loggable information, it calls a remote logger program/service 120 in the SAM server 118. The filter 114A, e.g., will connect to the remote logger 120 via a network connection that optionally can include a storage area network (“SAN”) 124 as part of the communication path. Similarly, the filter 114B and filter 114C in clients 102B and 102C can reflect loggable information to the remote logger 120.

The remote logger 120 calls a local logger 122 using a blind call in the same, or at least a similar, manner that component 104 calls local logger 106 in the client 102A. The local logger 122 interacts with a local log file 110G and optionally log queue 108G in the same manner as logger 106 interacts with file 110A and queue 108A.

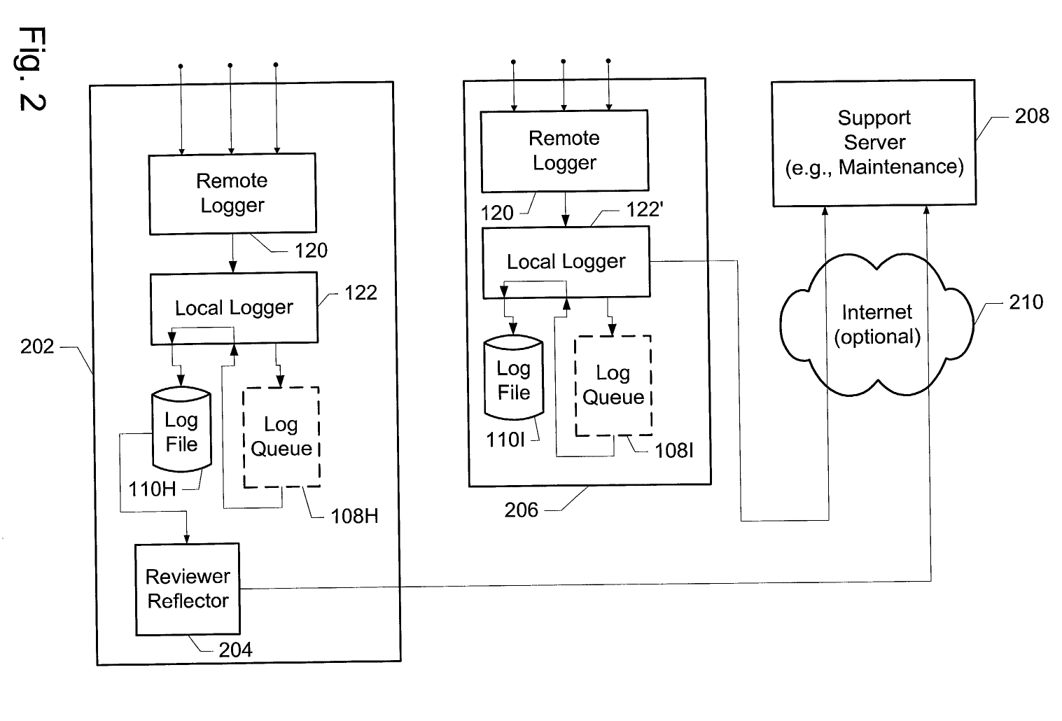

FIG. 2 is a block diagram depiction of a data logging and reflection system according to a second embodiment of the invention.

In FIG. 2, an alternative version of the SAM server 118 is depicted as server 202. Server 202 has similar components 108H and 110H to those in server 118. In addition, server 202 includes a reviewer-reflector service/program 204 that can access the log file 110H. The reviewer-reflector 204 can contact a support server, e.g., a server of a maintenance provider, 208 via a network connection that can optionally include the Internet 210. FIG. 2 also includes a second alternative version of the SAM server 118, namely the server 206. The server 206 differs from the SAM server 118 in that the local logger 122′ can contact the support server 208 in the same, or at least a similar, manner as the reviewer-reflector 204 can contact the support server 208, i.e., through a network connection that optionally includes the Internet 210. Otherwise, server 206 has similar components 108I and 110I to those in server 118.

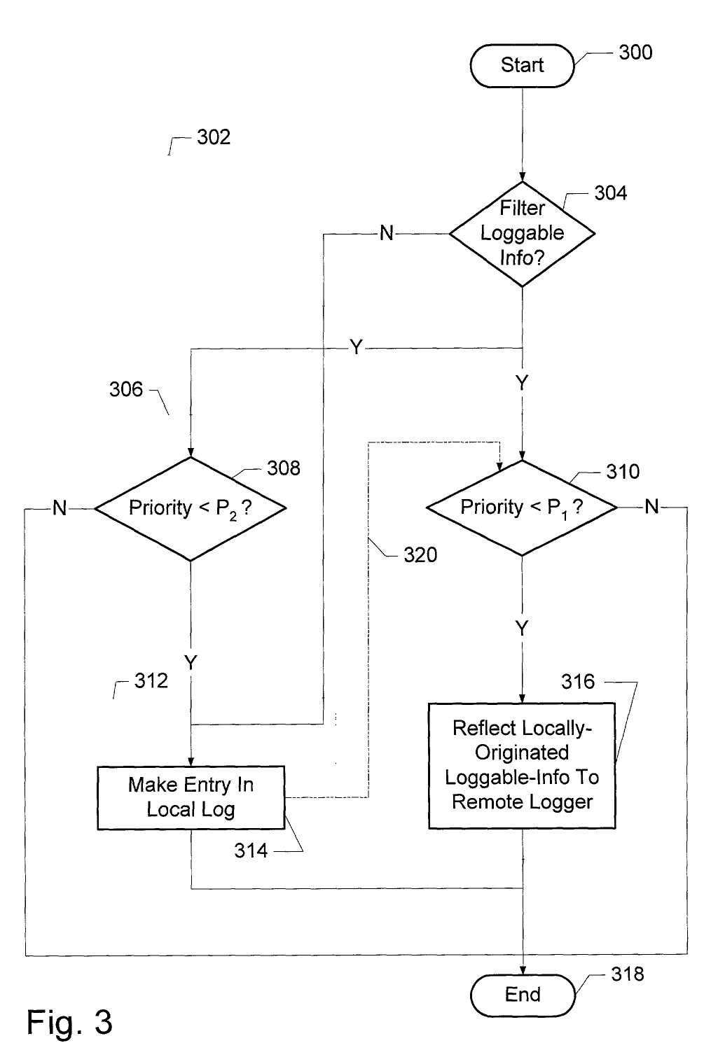

The operation of the first embodiment will now be discussed in terms of the flowchart of FIG. 3. In FIG. 3, flow begins at step 300 and proceeds to decision step 304. At step 304, it is determined whether the information which a component 104 or 112 wishes to log locally is to be filtered. If so, then flow proceeds to both steps 308 and 310. If not, then flow proceeds directly to step 314 (to be discussed below), skipping step 308. It is to be noted that step 304 can be performed by either the component/service 104 or the component/service 112.

At decision step 308, it is determined whether the priority assigned to the information that the component/service 104/112 wishes to be logged has a priority that is less than a reference value P₂. If so, then flow proceeds to step 314 where an entry is made in the local log 110B/D/F. But if the priority is not less than P₂, i.e., if P is equal to or greater than (≧) P₂, then flow proceeds to the end at 318, i.e., no local log entry is made. Previously, it was noted that flow could proceed directly from step 304 to step 314. In that circumstance, an entry is made at step 314 into the local log 110A/C/E because the component 104 has made a blind call to the local logger 106.

Flow also proceeds from step 304 to decision step 310. At step 310, it is determined whether the priority of the information to be logged is less than (<) a reference value P₁. If so, then flow proceeds to step 316, where the locally-originated loggable information is reflected to the remote logger 120. Flow proceeds from step 316 to the end (318). But if the priority is equal to or greater than (≧) P₁ at step 310, then flow proceeds directly to the end (318) i.e., no reflection is made.

Alternatively, steps 308 and 310 (but not 316) can be performed by the filter 114. In that circumstance, steps 314 and 316 would be performed by the local logger 116A. As such, phantom lines are shown extending from the local loggers 116A/B/C to the remote logger 120. As another alternative, in the embodiment of FIG. 3, steps 308, 310, and 316 are all performed by filter 114A as indicated by the phantom box 306. Step 314 is performed by the local logger 116A as indicated by the phantom box 312. The local logger service 116A/B/C can be coded to perform one or both of these steps. For instance if, while performing step 304, the filter 114 determines that information should be logged, then the local logger 116A/B/C could determine whether that information satisfies the criterion for reflection.

Alternatively, the processing can be arranged so that only information which satisfies the criterion of making an entry in the local log is considered for reflection to the remote logger 120. This alternative, i.e., cascaded, technique would delete the flow directly from step 304 to step 310 and so is depicted via the phantom line 320 from step 314 to step 310.

The flowchart of FIG. 3 assumes a priority scheme in which lower priority numbers represent greater importance, with the highest priority being zero. Typically, the reflection threshold, i.e., Pi, will be smaller than the logging threshold, namely P₂, i.e., P₁<P₂. Other priority schemes can be used.

In addition, the present embodiments use priority as the criterion for logging as well as the criterion for reflection. Other criteria could be used for the logging threshold and/or reflection threshold.

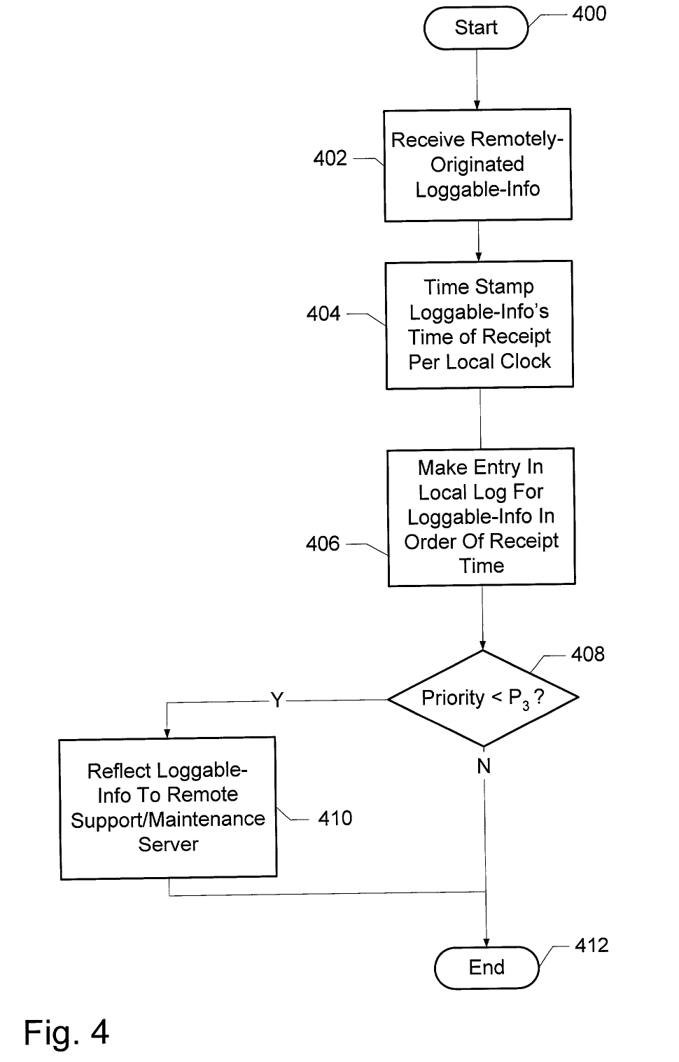

The operation of the servers 202/206 will now be discussed in terms of the flowchart of FIG. 4. Flow starts at step 400 and proceeds to step 402, where the remote logger 120 receives remotely-originated loggable information, e.g., from one or more of the filters 114A, 114B and 114C (each of which is remote to the server 202/206). Flow proceeds to step 404 where the remote logger 120 stamps the loggable information's time of receipt according to the local clock (not depicted) of the server 202/206. Flow proceeds to step 406 where the remote logger 120 calls the local logger 122 using a blind call, i.e., in such a way that the local logger 122 will log every instance of information provided to it by the remote logger 120. Again, this is similar to the operation of the local logger 106 of FIG. 1.

Flow proceeds in FIG. 4 from step 406 to decision step 408. It is determined in step 408 whether the priority of the just-logged instance of information is less than a support threshold, namely P₃. If the priority is less then P₃, then flow proceeds to 410 where the information is reflected to the support server 208 via a network connection that optionally can include the Internet 210. From step 410, flow proceeds to the end (step 412). Similarly, if the priority is equal to or greater than P₃, then flow ends (step 412).

In the circumstance that the steps of FIG. 4 are implemented by the server 202, steps 402 and 404 are performed by the remote logger 120, step 406 is performed by the local logger 122 and steps 408 and 410 are performed by the reviewer-reflector service 204. In the circumstance that the steps of FIG. 4 are performed by the server 206, the steps 406, 408, and 410 are all performed by the local logger 122′.

It should be noted that the role of the review/reflector 204 in FIG. 2 is analogous to the roles of the components 104 and 112 in FIG. 1.

The time stamping of step 404 and the making of a log entry in step 406 confers an advantage on the resulting log file 110H/110I. The entries in the log file 110H/110I are ordered chronologically according to their time of receipt by the remote logger 120 as determined by the local clock (not depicted) of the server 202/206. Where the clocks local to the clients 102A, 102B and 102C are out of sync, ordering the entries in the log file 110H/110I according to the local clocks of servers 202/206 will substantially always reflect the true sequence of occurrence. This is a significant advantage.

There may be some instances in which information travels from a first client, i.e., 102B, to the remote logger 120 much faster than from a second client, e.g., 102C because of differences in the communication path link. If the path link from client 102C is much longer or slower than the communication path link from client 102B, it is possible that information could be sent from local logger 116C to remote logger 120 before other information is sent from local logger 116B to remote 120 and yet the information from the logger 116B could arrive before the information from logger 116C. In that situation, ordering the entries in log file 110H/110I would not accurately reflect the true sequence of occurrence in time. But this circumstance is expected to occur very rarely, if at all, within the storage area environment managed by a single SAM server.

Alternative schemes for preserving the true sequence of origination in time for the entries in log file 110H/110I could be used.

The services 104 and 106, 110, 112, 114, 116, 120 and 122 are written/configured to operate in a distributed computing environment, e.g., the JINI brand made available by SUN MICROSYSTEMS INC., the JCORE brand made available by THE HEWLETT-PACKARD COMPANY, etc. In such a distributed computing environment, each of these services is either a provider of a service or a client/consumer of a service that communicates by a distributed communication protocol, e.g., JINI protocol, JCORE protocol, etc. See, e.g.,

www.wswest.sun.com\JINI\whitepapers\JINI-datasheet0601.pdf,

HTTP://Pandonia.canberra.edu.au/java/JINI/tutorial/JINI.html,

HTTP://www.sun.com/JINI/whitepapers/JINI-execoverview.pdf or

HTTP://www.billday.com/work/JINI/JINI.pdf.

An advantage of the server 202 and the server 206 is that the reviewer reflector 204 and local logger 122 prime, respectively, communicate via known network connections that optionally can include the Internet 210. In other words, neither the reviewer-reflector 204 nor the local logger 122 prime requires its own modem and dedicated phone line. Rather, it can use the pre-existing Internet access capability of computing environment in which it is loaded.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of logging information, the method comprising:
receiving a notice of locally-originated loggable information;
determining whether said information satisfies a first criterion; and
notifying, if said first criterion is satisfied, a remote logger service of said information.

2. The method of claim 1, further comprising:
making an entry in a local log for the information corresponding to said notice.

3. The method of claim 2, the method further comprising:
determining, before said step of making an entry, whether said information satisfies a second criterion different than said first criterion;
wherein said step of making an entry is contingent upon said second criterion having been satisfied.

4. The method of claim 3, wherein and said step of notifying is contingent upon said second criterion having been satisfied.

5. The method of claim 3, wherein said first criterion and said second criterion are respective levels of information priority.

6. The method of claim 5, wherein:
a scheme of said information priority assigns smaller numbers to higher priority information and larger numbers to lower priority information, the highest priority information having priority number zero; and
the first criterion is that an information must be lower in priority number than a first predetermined value, and said second criterion is that an information must be lower in priority number than a second predetermined value.

7. The method of claim 6, wherein said first predetermined value is smaller than said second predetermined value.

8. The method of claim 1, wherein said remote logger is of such remoteness as to include a storage area network (“SAN”) as part of a communication path thereto.

9. The method of claim 1, wherein said first criterion is a level of information priority.

10. A method of logging information, the method comprising:
receiving a notice of locally-originated loggable information;
determining whether said information satisfies a logging criterion;
making an entry, where said logging criterion is satisfied, in a local log for the information corresponding to said notice;
determining whether said information satisfies a reflection criterion different than said first criterion; and
notifying, if said reflection criterion is satisfied, a remote logger service of said information.

11. A method of logging information, the method comprising:
receiving multiple instances of remotely-originated loggable information; and
making entries in a local log for said multiple instances of remotely-originated loggable information.

12. The method of claim 11, wherein at least two of said instances of remotely-originated loggable information originate from sources having clocks that are out of sync such that an overall order of occurrence among all of said instances of loggable information is obscured;
the method further comprising:
approximating an order of occurrence among all of said instances of loggable information;
wherein said step of making entries makes said entries according to the approximated order of occurrence.

13. The method of claim 12, wherein said step of approximating includes:
time-stamping each receipt of said remotely-originated loggable information with a corresponding receipt time according to a clock local to the point of receipt;
wherein said step of making entries arranges said entries in order of the respective time stamps.

14. The method of claim 11, wherein each of said instances of instances of remotely-originated loggable information was logged locally before having been sent to the point of receipt.

15. The method of claim 11, the method further comprising:
determining, for each entry in said local log, whether information corresponding to said entry satisfies a first criterion; and
notifying, if said first criterion is satisfied, a remote service of said information.

16. The method of claim 15, wherein said remote service is of such remoteness as to include a storage area network (“SAN”) as part of a communication path thereto.

17. The method of claim 11, wherein at least one source of said remotely-originated loggable information is of such remoteness as to include a storage area network (“SAN”) as part of a communication path thereto.

18. A method of logging information, the method comprising:
receiving multiple instances of remotely-originated loggable information; and
wherein at least two of said instances of remotely-originated loggable information originate from sources having clocks that are out of sync such that an overall order of occurrence among all of said instances of loggable information is obscured;
approximating an order of occurrence among all of said instances of loggable information by time-stamping each receipt of said remotely-originated loggable information with a corresponding receipt time according to a clock local to the point of receipt;
making entries in a local log by arranging said entries in order of the respective time stamps.

19. A method of logging information, the method comprising:
providing access to a local log of remotely-originated information;
determining whether information corresponding to an entry in said local log satisfies a first criterion; and
notifying, if said first criterion is satisfied, a remote service of said information.

20. The method of claim 19, wherein said remote service is at least one of a support provider or a maintenance provider.

21. The method of claim 19, wherein said remote service is of such remoteness as to include the Internet as part of a communication path thereto.

22. The method of claim 19, wherein each instance of said remotely-originated information was logged locally before being sent to the point of receipt.

23. A method of logging information, the method comprising:
providing access to a local log of remotely-originated information, each instance of said remotely-originated information having been logged locally before being sent to the point of receipt;
determining whether information corresponding to an entry in said local log satisfies a first criterion; and
notifying, if said first criterion is satisfied, a remote service of said information, wherein said remote service is at least one of a support provider or a maintenance provider;
wherein said remote service is of such remoteness as to include the Internet as part of a communication path thereto.

24. An apparatus operable to perform the method of claim 1.

25. A computer-readable medium having code portions embodied thereon that, when read by a processor, cause said processor to perform the method of claim 1.

26. The computer-readable medium of claim 25, wherein said code portions are configured to adhere to JINI distributed computing technology or JCORE distributed computing technology.

27. An apparatus operable to perform the method of claim 11.

28. A computer-readable medium having code portions embodied thereon that, when read by a processor, cause said processor to perform the method of claim 11.

29. The computer-readable medium of claim 28, wherein said code portions are configured to adhere to JINI distributed computing technology or JCORE distributed computing technology.

30. An apparatus operable to perform the method of claim 19.

31. A computer-readable medium having code portions embodied thereon that, when read by a processor, cause said processor to perform the method of claim 19.

32. The computer-readable medium of claim 31, wherein said code portions are configured to adhere to JINI distributed computing technology or JCORE distributed computing technology.
